(19) United States
(12) Patent Application Publication
(10) Pub. No.: US 2014/0185980 A1
(43) Pub. Date: Jul. 3, 2014

(54) Silicon-On-Insulator Platform for Integration of Tunable Laser Arrays

(71) Applicant: FUTUREWEI TECHNOLOGIES, INC., Plano, TX (US)

(72) Inventors: Hongbing Lei, Sunnyvale, CA (US); Xiao A. Shen, San Bruno, CA (US); Yusheng Bai, Los Altos Hills, CA (US)

(73) Assignee: FUTUREWEI TECHNOLOGIES, INC., Plano, TX (US)

(21) Appl. No.: 13/732,168

(22) Filed: Dec. 31, 2012

(51) Int. Cl. H01S 3/10; H05B 37/02; G02B 6/12

(52) U.S. Cl. CPC H01S 3/10; G02B 6/12007; H05B 37/02
USPC 385/14; 372/20; 315/291

(57) ABSTRACT

An apparatus comprising a silicon-on-insulator (SOI) platform comprising an optical component network. An apparatus comprising an optical component network monolithically grown on a SOI platform, and an optical device coupled to the optical component network. A method comprising generating an optical signal using a silicon-based optical component, applying an electrical signal to the optical component, and tuning a wavelength of the optical signal based on the electrical signal.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Photonic integration has been playing an increasingly important role in optical systems, such as transport and interconnect devices. Photonic integration may bring about various benefits, such as relatively smaller footprint, higher port density, less power consumption, and/or reduced cost, making it a preferred technology for building the next generation of integrated optical devices, such as wavelength division multiplexing (WDM) transponders, transceivers, and other types of devices. A Group III-V compound, indium phosphide (InP), used to be a preferred choice of material for photonic integration, e.g., for WDM transport applications, because it is a good lasing material for C-band (e.g., wavelength between about 1470 to 1610 nanometers) transmission. Monolithic integration of up to 10 transmitters or receivers has been demonstrated using InP chips. However, InP-based monolithic integration may bring potential disadvantages or issues, which may include small wafer size (e.g., 2 to 3 inches), high killer defect density, and brittleness of InP, which may require additional submount(s) as a chip carrier.

To avoid issues of monolithic integration, hybrid integration has been used as an alternative solution for photonic integration. In this approach, at least some components of the optical system are not monolithically grown, but are bonded to a carrier or platform instead. Hybrid integration may be based on a silica-on-silicon (SOS) platform, which is often used to grow a planar lightwave circuit (PLC). PLC may comprise passive optical components, such as optical waveguides, splitters, combiners, optical taps, which may be readily grown with low insertion loss. In addition, PLC may also serve as a platform on which active components (e.g., modulator and laser) may be readily mounted. According to U.S. Pat. No. 8,285,151, twelve distributed feedback laser (DFB) lasers may be hybrid integrated on a PLC carrier and may have a function of wavelength multiplexing to form a dense WDM (DWDM) transmitter array.

Although SOS materials may be a good material for development of passive optical components and serving as a chip carrier, SOS materials may lacks other integration capabilities needed to be a complete solution for optical transport/interconnect. These lacking capabilities may include optical signal modulation, signal attenuation, tunable filtering, and so forth. Currently, these functions are either not implemented, or implemented only with a small scale to simplify the integration. Complex and/or large-scale integration of optical components may require a different platform using the hybrid approach.

### SUMMARY

In one embodiment, the disclosure includes an apparatus comprising a silicon-on-insulator (SOI) platform comprising an optical component network.

In another embodiment, the disclosure includes an apparatus comprising an optical component network monolithically grown on a SOI platform, and an optical device coupled to the optical component network.

In yet another embodiment, the disclosure includes a method comprising generating an optical signal using a silicon-based optical component, applying an electrical signal to the optical component, and tuning a wavelength of the optical signal based on the electrical signal.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of an optical assembly.

FIG. 2 is a schematic diagram showing carrier injection across a P-N junction.

FIG. 3 is another schematic diagram of an embodiment of an optical assembly.

FIG. 4 is a schematic diagram showing an electrical interface and an optical interface between an optical device and a SOI platform.

FIG. 5 is another schematic diagram showing an interface between an optical device and a SOI platform.

FIG. 6 is another schematic diagram showing a cross-sectional view of an assembly.

FIG. 7 is yet another schematic diagram showing a cross-sectional view of an assembly.

FIG. 8 is a schematic diagram showing an optical interface between a first waveguide and a second waveguide.

FIGS. 9A and 9B are other schematic diagrams of an embodiment of an optical assembly.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are apparatuses and methods for improved photonic hybrid integration. Embodiments of this disclosure may provide a high-volume and low-cost solution to the integration of tunable laser arrays, which may be used in optical transport systems and interconnects. Specifically, instead of the traditionally used SOS platform, a silicon-on-insulator (SOI) carrier or platform may be used herein for photonic integration. In an embodiment, the SOI platform may be used to monolithically grow an optical component network comprising one or more optical components. For example, parts of a laser array based on distributed Bragg reflectors (DBR) may be grown on the SOI platform. Further, the SOI platform may be coupled to another optical device, e.g., via a flip-chip bonding method. In an embodiment, the coupled optical device is a gain chip coupled to a number of DBR lasers to form a laser array for WDM applications. Each laser in the array may use one set of Bragg gratings to form a laser cavity with the gain chip. Alternatively, each laser may use two sets of Bragg gratings on one side of the gain chip to form a folded laser cavity with the gain chip. Wavelengths the lasers may be tunable by thermally or electrically tuning the Bragg gratings. In addition, passive flip-chip bonding may align optical waveguides with the help of vertical stoppers as well as horizontal markers. Moreover, mode convertors may be used to improve optical coupling between SOI waveguides and the coupled optical device.

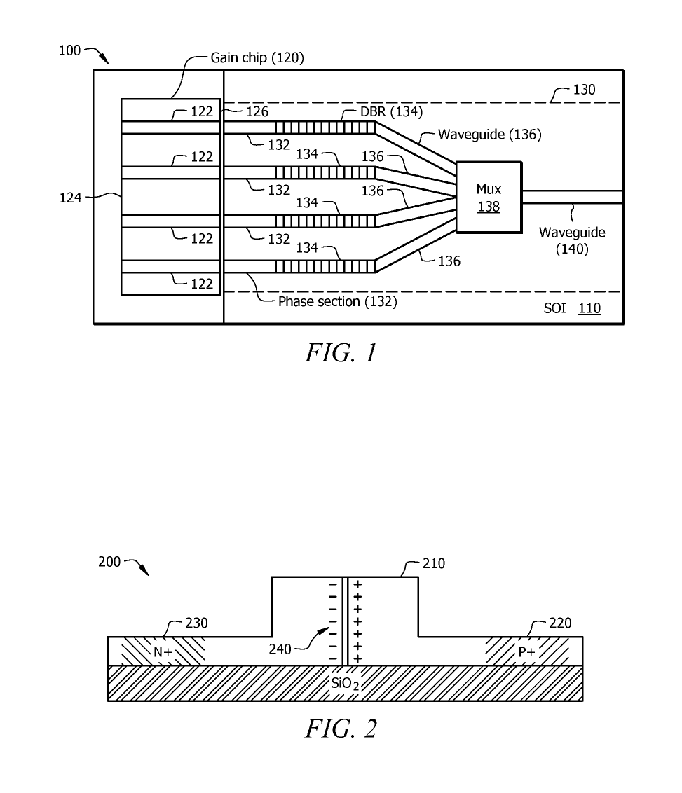

FIG. 1 is a schematic diagram of an embodiment of an optical assembly 100, which shows an example of an array of four DBR lasers whose outputs are wavelength multiplexed into a single waveguide for WDM applications. The optical assembly 100 may comprise a SOI carrier or platform 110 and a gain chip 120 coupled to the SOI platform 110. FIG. 1 may be considered a top view of the optical assembly 100, assuming that the SOI platform 110 is situated underneath the gain chip 120. As used herein, “top”, “bottom”, “front”, “back”, “left”, “right”, “inner”, “outer”, or any other term that references a relative position is with respect to the perspective view referenced and does not mean to imply that a device is restricted to only one orientation.

The SOI platform 110 may be a chip or wafer comprising a silicon layer on top and an insulator (e.g., silica) layer underneath the silicon layer. An optical component network 130 comprising one or more optical components may be monolithically fabricated or grown on the SOI platform 110. As shown in FIG. 1, each of the DBR lasers may comprise a phase section 132, a set of Bragg gratings 134 coupled to the phase section 132, and an output waveguide 136 coupled to the set of gratings 134. The four output waveguides 136 may be further coupled to a multiplexer 138, which may often be denoted as a MUX. Moreover, there may be another waveguide 140 coupled to the multiplexer 138 and configured to transmit an output optical signal, e.g., to another optical device or component network. The phase sections 132, the sets of gratings 134, the output waveguide 136, the multiplexer 138, and the waveguide 140, collectively considered as the optical component network 130, may be monolithically fabricated from the SOI platform 110. Accordingly, the optical component network 130 may be considered part of the SOI platform 110. In other words, the SOI platform 110 may comprise the optical component network 130. Monolithic fabrication of the optical component network may use any suitable technologies, e.g., via deposition, etching, and/or doping of a SOI wafer.

It should be understood that FIG. 1 merely serves as an application example of SOI-based optical assembly. Thus, other designs or configurations of optical components and/or optical devices may also be similarly realized within scope of this disclosure. For example, any other number of DBR lasers may be constructed using the assembly 100. For another example, the optical component network 130 may comprise any suitable type or types of optical components, which may include passive and/or active components. For example, the optical component network 110 may include passive functionalities or components, such as splitter, tap, and/or combiner. Depending on the application, instead of the gain chip 120, any other type of optical device or block may be coupled to the SOI platform 110 via a non-monolithic fashion. Further, a plurality of optical devices may be coupled to the SOI platform 110.

The gain chip 120 may comprise any suitable material, e.g., a Group III-V compound. In an embodiment, the gain chip 120 may be made of indium phosphide (InP). The gain chip 120 may be mounted on the SOI platform via any suitable coupling method, such as a flip-chip bonding method, a butt joint method, or an adiabatical coupling method. For example, to accommodate flip-chip bonding, a portion of the SOI platform underneath the gain chip 120 may be etched, so that the waveguides 122 may have an equal height with the phase sections 132, allowing direct coupling of light from the gain chip 120 to the optical component network 130.

Consider DBR lasers as an application example. The gain chip 120 may comprise four waveguides 122 coupled to the four phase sections 132 via an optical interface. Further, the gain chip 120 may be anti-reflective on a side 126 coupled to the phase sections 132 and highly reflective on an opposite side 124. This may be realized by coating an anti-reflection material on the side 126 and high-reflection material on the side 124. As a result, for each laser, a laser cavity comprising the waveguide 122, the phase section 132, and the set of gratings 134 may be formed, with the waveguide 122 being a gain section. The side 124 works as one end or minor of the laser cavity, and the gratings 134 as the other end of the laser cavity. The set of gratings 134 may be written on a SOI waveguide and comprise refractive index gratings with a desired spacing or pitch to form a wavelength selective mirror. Pitches of the gratings 134, often referred to as distributed Bragg reflectors (DBR), may be distributed uniformly or non-uniformly. The set of gratings 134 may be designed to have a desired transmission and reflection ratios (e.g., 20% transmission and 80% reflection), and these ratios are wavelength dependent.

In operation, a laser may oscillate inside the laser cavity, and certain wavelength(s) of the laser may be amplified as an output, with other wavelength filtered. The phase section 132 may be adjusted to allow laser of certain wavelength(s) to oscillate. In an embodiment, the phase section 132 may tune a phase by changing refractive index, e.g., via temperature change or an electrical field. Similarly, the set of Bragg gratings 134 may tune a wavelength via thermal tuning or electrical tuning. The wavelength of each DBR laser may be mainly tuned or determined by the set of gratings 134. Further, the output signals from all four DBR lasers may feed into the multiplexer 138, and combined into a single signal to be emitted or transmitted out via the waveguide 140. The multiplexer 138 may be a multimode interference (MMI) coupler or an arrayed waveguide gratings (AWG), or any other type of multiplexer, depending on the application or degree of integration. If desired, the multiplexer 138 may be bonded to the SOI platform 110, instead of monolithically grown. Like a conventional laser array (e.g., DWDM array), multiple lasers may be wavelength multiplexed by the multiplexer 138 (e.g., an AWG). Unlike a conventional laser array, the cavity of each laser may be formed inside the waveguides leading to the AWG.

The configuration as shown in FIG. 1 may offer a tunable laser emitter or transmitter array with limited wavelength tuning capability, e.g., narrow band tuning in the range of about 0 to 8 nanometers (nm). Such a configuration may be ideal for DWDM applications, where fixed wavelengths are of interest. This configuration may also be used in a directly modulated laser (DML) if appropriate length of the cavity as well as gain chip design is used. In the DML, one or more electrical input signals may be fed to the gain chip 120 to modulate the output power of the lasers. For example, a forward biased current may be fed to an electrical trace coupled to a waveguide 122, changing the refractive index of the waveguide 122, and thereby changing the laser power.

The SOI platform 110 may offer a complementary substrate or platform for hybrid photonic integration on which certain active functionalities other than lasing are achievable. One example is a Mach-Zehnder modulator (MZM), which may be used as an optical device coupled to the SOI platform 110 and configured to modulate optical signals from a continuous wavelength (CW) laser source. The MZM may be made up with waveguides in a good optical material, whose refractive index may be altered by applying an electric field on one or two arms of the modulator. For example, the MZM may use properties of a semiconductor p-n junction to modify the index of one arm of the modulator relative to the other arm via either carrier injection and depletion or accumulation at the junction.

Conventionally, laser chips with complete components may often be coupled to a SOI platform. In this disclosure, when coupling an optical device with the SOI platform 110, heterogeneous integration, e.g., of InP and SOI, may use wafer bonding through van der Waals attraction between two surfaces at the atomic level. Further, with use of evanescent coupling, some laser parts, such as laser cavity, silicon waveguides, Bragg gratings, and other passive features may be developed on the SOI platform. The capability to transfer parts of a laser on to the SOI platform 110 may sometimes offer advantages in laser array integration. For example, by using the SOI platform 110 as a part of the laser cavity for array integration, potential changes to the laser cavity caused by stress/strain during or after die-bonding may be eliminated or reduced. In use, if a die for a complete laser is used rather than a gain chip, the bonding process, e.g., via flip-chip, may alter the center wavelength of the laser, and potentially decrease the manufacture yield.

As mentioned previously, a refractive index of the silicon-based Bragg gratings may be changed, which in turn may realize tuning of laser wavelength. One option is to use thermal tuning as silicon exhibits a relatively large thermo-optic coefficient. In thermal tuning, micro-sized heaters may be traced or placed on top of the Bragg gratings. For visual clarity, the electrical traces, electrodes, transmission lines, ground lines, termination resistors, etc., have been omitted in figures herein, unless pointed out specifically. During operation, currents in the micro heaters may be adjusted or turned on or off as desired, which leads to temperature changes, then refractive index changes, and eventually wavelength changes. For example, a one degree Celsius temperature change may tune a laser wavelength by 0.1 nm. However, thermal tuning may not be suitable for some applications, as it may consume relatively a high amount of power due the heaters and may operate at a relatively low speed as temperature changes may be slow.

The application of an electric field to a material can result in a change to the real and imaginary parts of a refractive index. In an embodiment, the Bragg gratings may be tuned electrically based on a plasma dispersion effect, in which the concentration of free charges in silicon may change the real and imaginary parts of the refractive index. FIG. 2 is a schematic diagram of an embodiment of a carrier injection scheme 200 across the P-N junction of a set of Bragg gratings 210. FIG. 2 is considered a side cross-sectional view along a plane perpendicular to the Bragg gratings. The set of Bragg gratings 210 may be any of the sets of gratings described herein. The P-N junction may be created underneath and across two sides of the Bragg gratings 210. In operation, an electrical field may be applied on the P-N junction, which may be created via adding dopants into silicon. Carrier injection may occur when the P-N junction is forward biased, that is, a P+ side 220 has a higher voltage than an opposite N+ side 230. Holes may be injected from the P+ side 220 into the N+ side 230 across a depletion region 240. The holes injected into the N+ side 230 are minority carriers. The depletion region 240 may be a region depleted of mobile carriers located at the center of the junction. One skilled in the art will recognize functioning of tuning using the plasma dispersion effect.

Electrical tuning based on plasma dispersion effect may be more suitable for silicon-based Bragg gratings compared with some traditionally used electrical effects, such as the Pockels effect, the Kerr effect, and the Franz-Keldysh effect. Although the traditionally used effects have been used to cause either electroabsorption or electrorefraction in other semiconductor materials, silicon may show weak responses to these effects in communications wavelengths of 1.3 micrometer (μm) to 1.55 μm. In addition, compared to thermal tuning, the plasma dispersion effect may be a more efficient mechanism to achieve large tunable range. An exemplary tuning range of a DBR laser may be about 8 nm. With electrical tuning and targeted value from the grating masks, a transmitter array may be built with desired wavelength spacing without needing thermal tuning. Furthermore, unlike a silica-on-silicon (SOS) platform, the Bragg gratings may be tuned efficiently by either carrier injection or depletion to form DWDM arrays with desired wavelengths. No micro heaters may be needed for wavelength tuning, which may reduce the power consumption of the laser arrays. Under this condition, an InP chip may act merely as a gain block, providing necessary population inversion in the laser cavity to obtain stimulated emission.

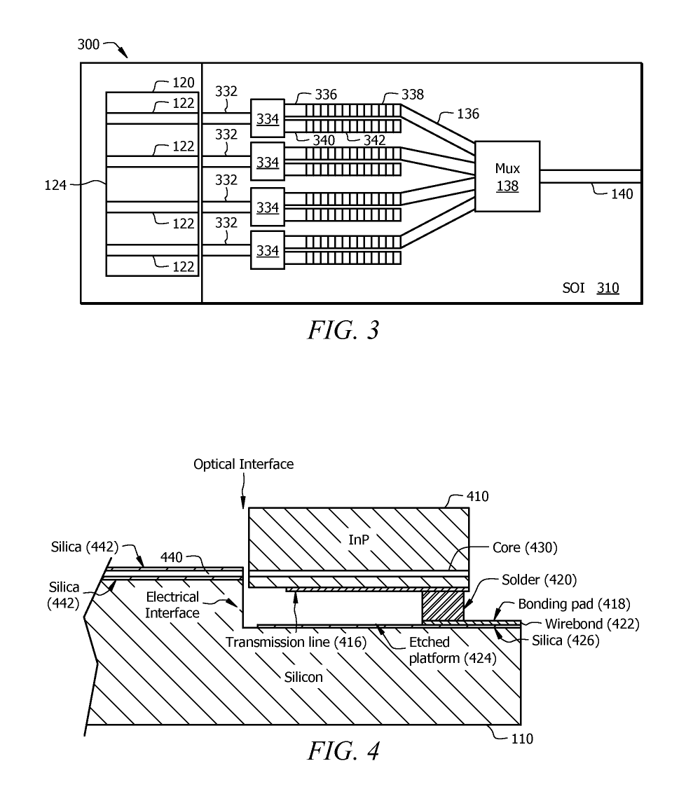

FIG. 3 is a schematic diagram of an embodiment of another optical assembly 300, which has various aspects that are the same with or similar to the assembly 100. In the interest of conciseness, further descriptions may focus on the aspects that are different. The assembly 300 comprises a SOI platform 310 and the gain chip 120 coupled to the SOI platform 310. Similar to FIG. 1, the SOI platform 310 comprises an optical component network including parts of four lasers. Unlike the assembly 100 which may have only one set of gratings for each laser or laser branch, the assembly 300 may have at least two arms or sets of gratings for each laser or laser branch. Each laser may comprise a first phase section 332, a coupler 334, a second phase section 336, a first set of Bragg gratings 338, a third phase section 340, and a second set of Bragg gratings 338, arranged and coupled as shown in FIG. 3.

The phase sections 332, 336, and 340 may be similar to the phase section 132 in FIG. 1, and may be tuned thermally or electrically. In particular, the phase sections 336 and 340 may be extra sections configured to control the phase difference of a laser between the two reflections. The two sets of gratings 338 and 342 may be written on separate waveguides, and may be connected on the same side of the coupler 334 to form effectively a folded laser cavity. The coupler 334 may be a wide-band or broad-band coupler. The coupler 334 may be a bidirectional module that functions as a laser power splitter in one direction and a laser coherent combiner in the opposite direction. The two sets of gratings 338 and 342 may comprise multi-peak reflectors with non-uniform pitches, and reflection peak periodicity of the two gratings may differ slightly. For example, a free spectral range (FSR), which may depend on pitch distribution, for the two sets of gratings 338 and 342 may have about 10% difference. The output lasing wavelength may be determined by the peaks from the separate reflectors that coincide in wavelength, along with necessary phase conditions for each arm. The two sets of gratings 338 and 342 may function similarly to the gratings 134 and may be tuned thermally or electrically.

Due to combinations of tuning in both sets of gratings, the folded cavity configuration as shown in FIG. 3 may achieve a wider tuning range of wavelength, compared with the assembly 100. For example, the tuning range may be up to about 40-50 nm and may cover the entire C-band. Thus, the assembly 300 may be suitable to use as a widely tunable laser array. Further, the assembly 300 may be based on Vernier effect using two multi-peak reflection gratings, which is similar to a sample grating distributed Bragg reflector (SG-DBR) laser. However, unlike the SG-DBR which has front and back tuning sections positioned on opposite sides of a gain chip, the assembly 300 may have tuning sections positioned on the same side of the gain chip. Thus, due to the folded cavity formed by the two arms, an effective length of laser cavity may be relatively longer in the assembly 300, which may lead to a narrower wavelength line-width at the output. As such, a sharper laser may be produced, which is ideal for narrow line-width applications.

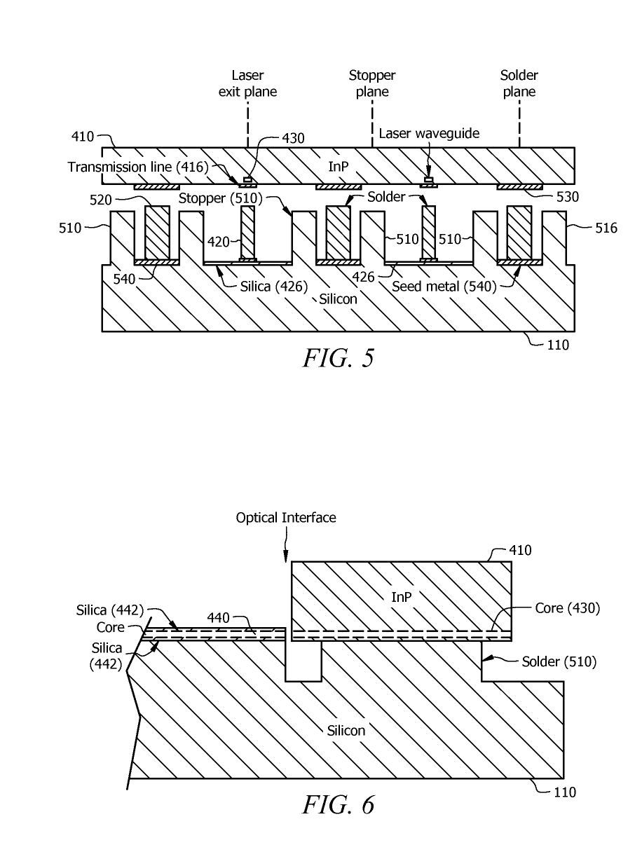

In an embodiment, an optical device (e.g., the gain chip 120) and the SOI platform 110 may be integrated using a flip-chip bonding method. FIG. 4 illustrates an embodiment of an electrical interface and an optical interface between an optical device 410 and the SOI platform 110. FIG. 4 may be considered a front side cross-sectional view (e.g. taken along the laser exit plane in FIG. 5). Note that depending whether the optical device is a passive or active device, the electrical interface may or may not be necessary. For example, if the optical device 410 is a MZM, then the electrical interface is needed. In the electrical interface, the wire bond 422 may serve as a contact point to an electrical input signal, such as radio frequency signal. The wire bond 422 may be part of a bonding pad 418 or may be connected to the bonding pad 418, e.g., via a gold strip. The wire bond 422 and the bonding pad 418 may be two ends of a single metal pad (e.g., made of gold). The bonding pad 418 may reside on top of an etched platform 424. Underneath the platform 424 is a silica layer 426 obtained by processing the SOI platform 110. The silica layer 426 may help bond gold to the etched platform 424. Additionally, the bonding pad 418 is coupled to a signal trace or transmission line 416 on the optical device 410 via a solder 420. Depending on the application, another end of the transmission line 416 may be coupled directly to a ground line, or to another bonding pad (not shown in FIG. 4). For example, sometimes when a termination resister is used, two ends of the transmission line 416 may be coupled to bonding pads on the etched platform 424.

In operation of a MZM modulator, for example, a radio frequency (RF) signal may first be fed from a wall of the package body via the wire bond 422 to the transmission line 416. The transmission line 416 may be positioned underneath and close to a laser waveguide with a core 430, which may be an arm of the MZM. Optical signals passing through the core 430 may be modulated in intensity and/or phase. In use, the transmission line 416 may comprise a relatively wider portion, which serves as a bonding pad to form an electrical connection. The electrical connection may be achieved by solder jointing of bonding pads located on both the optical device 410 and the SOI platform 110. The solder 420 may comprise any fusible metal or metallic alloy used to join metal work pieces and having a melting point below that of the work piece(s). Exemplary soldering materials include, tin, copper, silver, bismuth, indium, zinc, antimony, and any combination thereof.

The optical interface between the optical device 410 and the SOI platform 110 may be formed by aligning the core 430 with a core 440. The cores 430 and 440 may be various types of waveguides described previously. The core 440 may be grown on the SOI platform 110 and have two silica layers 442 on both sides as claddings. To vertically align the two cores, the SOI platform 110 may be partially etched during fabrication of the device assembly so that the waveguide cores 430 and 440 in the optical device 410 and the SOI platform 110 may be aligned at an equal height, as shown in FIG. 4.

FIG. 5 is another schematic diagram showing an interface between the optical device 410 and the SOI platform 110 formed via flip-chip bonding, which may be considered a right side cross-sectional view (e.g., a view parallel to the optical interface in FIG. 4). As shown in FIG. 5, the vertical alignment may be obtained through a number of protruding features 510 on the SOI platform 110, which may be referred to herein as stoppers 510. During fabrication, the stoppers 510 may be created via silicon etching on the SOI platform 110. For a stopper 510, its two sides may have different etching depths, e.g., with one side relatively shallower and another side relatively deeper. The shallower side may be designed to support electrical traces or patterns. For example, a shallower side may support a bonding pad 420, which may be connected to a transmission lien 416 via a solder 420. As the bonding pad 420 may be made of gold, which may have good adhesion to silica but poor adhesion to silicon, it may be desirable to create the silica layer 426 between the bonding pad 420 and the silicon layer of the SOI platform 110. On the other hand, the deeper side may provide mechanical support for the optical device 410. For example, a solder 520 may couple two bonding pads 530 and 540 together forming a mechanical and thermal interface. The bonding pad 540 may be deposited on the silicon surface, thus the bonding pad 540 may comprise metals which has good adhesion to silicon. In an embodiment, mechanical coupling between the optical device 410 and the SOI platform 110 may be achieved in area where there is no direct contact to any waveguide or electrical trace. This design may minimize or reduce any stress/strain induced birefringence as a result of the bonding, while keeping the mechanical/thermal characteristics of the interface uncompromised.

FIG. 6 is another view taken along the stopper plane shown in FIG. 5. As shown in FIG. 6, vertical alignment between the optical device 410 and the SOI platform 110 may be obtained through a number of stoppers 510 (only one shown in FIG. 6). The stoppers 510 may extend from an optical interface between the waveguide cores 430 and 440 to the other side of the optical device 410. In a PLC wafer etching process, the depth of silica etching may be precisely controlled. The stoppers 510 may be positioned a few (e.g., 2-10) micrometers below, but not necessarily directional underneath, the center of the waveguide core 430 in the optical device 410. Depending on the design, the stoppers 510 may sometimes be on the same vertical level with or even higher than the core 430. To align the waveguide core 430 with another waveguide core 440 (e.g., in the passive optical component network 130 or in another optical device bonded to the SOI platform 110), the depth of the waveguide core 430 (e.g., distance of the core 430 to the bottom surface of the optical device 410 in FIG. 6) may determine the height of the stoppers 510. Furthermore, during flip-chip bonding, the optical device 410 may be pressurized until it rests on the stoppers 510. A typical precision of passive alignment in the vertical direction using the stoppers 510 may be less than 1 micrometer.

Horizontal alignment of the optical device 410 with respect to the SOI platform 110 may be accomplished using markers on both the optical device 410 and the SOI platform 110. The markers on the optical device 410 may be generated during fabrication of the core 430 (etching inside InP), and the markers on the SOI platform 110 may be generated during fabrication of the stoppers 510. Markers on both devices may be placed near the optical interface area for easy alignment. In addition, to an extent, soldering may also help horizontal alignment of the SOI platform 110 and the optical device 410, since horizontal movement may be driven by a surface tension force in an effort to minimize the surface area to reaching the lowest total surface energy of the assembly.

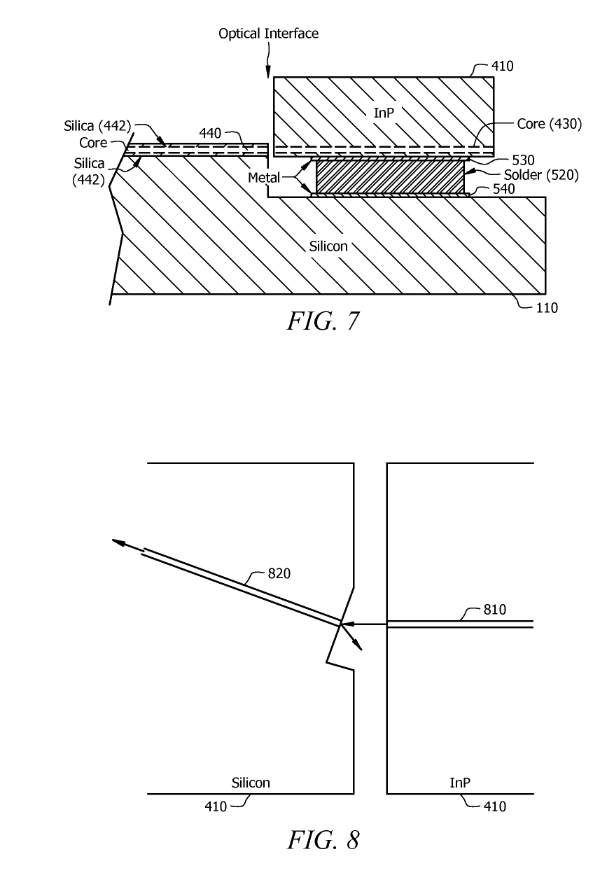

FIG. 7 is another view taken along the solder plane shown in FIG. 5. As shown in FIG. 7, the optical device 410 may be mechanically held together with the SOI platform 110 by the solder 520. Specifically, a first bonding pad 530 patterned on the optical device 410 may be coupled with a second bonding pad 540 patterned on the SOI platform 110 via the solder 520. In an embodiment, to provide good thermal conductivity between the optical device 410 comprising InP and the SOI platform 110 comprising silicon, the bonding pad 540 directly situates on silicon. Since the thermal conductivity of silicon is better than silica, this configuration may prove useful in case temperature control of the assembly is needed. Otherwise, silicon etching may stop at any level (e.g., the same level with areas supporting the RF electrode connections, along the laser exit plane, as shown in FIG. 5).

Flip-chip bonding of the optical device 410 on the SOI platform may offer good thermal stability in comparison to other bonding methods or approaches. For example, although a butt joint method may be used to form the optical interface via active alignment, as the optical device 410 may need to be repeatedly detached from the SOI platform 110 during alignment, the butt joint method may be thermally less stable compared to flip-chip bonding. The thermal stability may be important in some devices, e.g., where a precise path difference between two MZMs must be kept to maintain a fixed phase difference.

Mode convertors may sometimes be needed for both the optical device 410 and the SOI platform 110, in order to ensure good optical coupling at the optical interface. A mode converter may optimize the size and profile of an optical mode (e.g., laser) at the optical interface, and ensure good optical coupling between the optical device 410 and the SOI platform 110, e.g., with minimal loss of power.

FIG. 8 is a schematic diagram showing an optical interface between a first waveguide 810 and a second waveguide 820. The waveguide 810 may be inside the optical device 410 (e.g., the gain chip 120), and the waveguide 820 may be inside another optical device or an optical component network of the SOI platform 110. The waveguides 810 and 820 may be substantially similar with waveguides described previously, except that the direction of the waveguide 820 is tilted to create a horizontal misalignment with the waveguide 810, as shown in FIG. 8. The misalignment causes a direction of the waveguide 820 to be different from a direction of the waveguide 810. The misalignment angle may be greater than zero but less than 45 degrees, less than 30 degrees, or less than 15 degrees. As a result, an exit facet of the waveguide 820 may no longer face perpendicularly to an exit facet of the waveguide 810. This configuration may help reduce or minimize optical reflection from the etched PLC facet at the optical interface. For example, when an optical signal travels from the waveguide 810 to the waveguide 820 through an air gap, the optical signal may be partially reflected upon entrance into the waveguide 820, with horizontal tilting, the optical reflection at the etched interface may be directed away from the optical path.

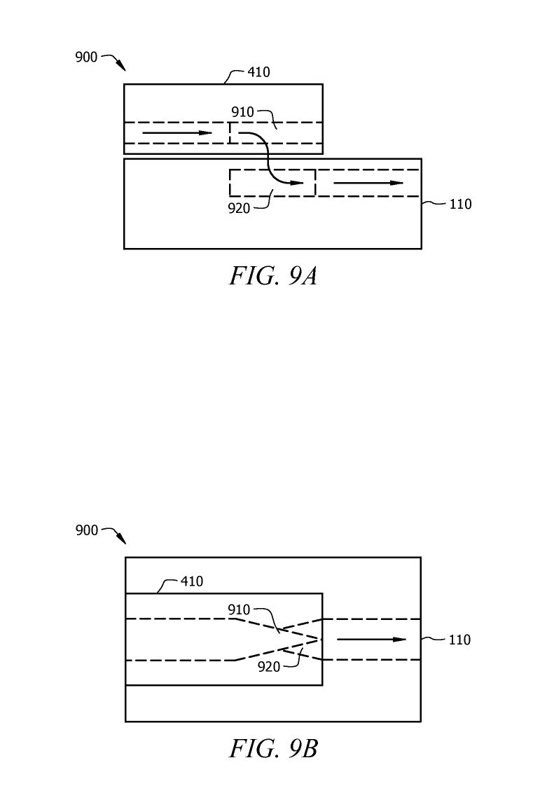

FIGS. 9A and 9B illustrate an embodiment of an optical assembly 900, which is bonded using an adiabatic tapered coupling method. FIG. 9A may be considered a side view and FIG. 9B a top view. In the assembly, the optical device 410 may be bonded on the SOI platform 110 via flip-chip. As shown in FIG. 9A, a waveguide 910 located in the optical device 410 may have a portion vertically overlapping a portion of another waveguide 920, which is located in the SOI platform 110. For example, an optical signal may be transferred from the waveguide 910 to the waveguide 920. At a coupling or overlapping area, the width of the waveguide 910 may change smoothly from a normal width to a smaller tip. As a result, an optical mode confinement may become weaker and weaker. In addition, in the coupling area, the width of the waveguide 920 widen from a small tip to a normal width, and light guiding of the optical signal may become stronger and stronger. After two waveguide taper pattern optimization, the optical mode from the optical device, which may be a laser, may be efficiently coupled to the silicon-based waveguide 920. The adiabatic coupling may be insensitive to wavelength and tolerant to misalignment introduced by passive alignment in the flip-chip bonding process. Thus, this coupling method may prove useful in implementation.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, e.g., k is 1 percent, 2 percent, 3 percent, 4 percent, 5 percent, . . . , 70 percent, 71 percent, 72 percent, . . . , 95 percent, 96 percent, 97 percent, 98 percent, 99 percent, or 100 percent. Moreover, any numerical range defined by two R numbers as defined in the above is also specifically disclosed. The use of the term “about” means±10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. An apparatus comprising:
a silicon-on-insulator (SOI) platform comprising an optical component network.

2. The apparatus of claim 1, wherein the optical component network comprises parts of a tunable laser.

3. The apparatus of claim 1, wherein the optical component network comprises a set of gratings configured to tune an output wavelength of a laser.

4. The apparatus of claim 3, wherein the output wavelength of the laser is tuned using a temperature change in the set of gratings.

5. The apparatus of claim 3, wherein the output wavelength of the laser is tuned using an electrical field applied to the set of gratings.

6. The apparatus of claim 3, wherein the set of gratings comprises a P-N junction, wherein the SOI platform further comprises an electrical trace configured to cause a forward bias in the P-N junction, and wherein the output wavelength of the laser is tuned using injection of carriers in the P-N junction under the forward bias.

7. The apparatus of claim 3, wherein the optical component network further comprises:
at least one additional set of gratings, wherein each additional set of gratings is configured to tune an output wavelength of an additional laser; and
a multiplexer coupled to the set of gratings and the additional set of gratings via waveguides, wherein the multiplexer is configured to multiplex the laser and the additional laser into one waveguide.

8. The apparatus of claim 1, wherein the optical component network comprises a coupler and two sets of gratings coupled to the coupler via two phase sections positioned on one side of the coupler and configured to tune an output wavelength of one laser, and wherein the two sets of gratings have different pitch distributions.

9. An apparatus comprising:
an optical component network monolithically grown on a silicon-on-insulator (SOI) platform; and
an optical device coupled to the optical component network.

10. The apparatus of claim 9, wherein the optical device and a number of components in the optical component network are configured to produce an optical signal, and wherein a wavelength of the optical signal is tunable.

11. The apparatus of claim 10, wherein the wavelength of the optical signal is tunable based on a plasma dispersion effect.

12. The apparatus of claim 9, wherein the optical component network comprises a set of Bragg gratings and a first waveguide coupled to the set of Bragg gratings, wherein the optical device is a gain chip comprising a second waveguide, wherein the second waveguide is coupled to the first waveguide, and wherein the set of Bragg gratings and the first and second waveguides form an optical cavity.

13. The apparatus of claim 9, wherein the optical component network comprises:
a first set of Bragg gratings;
a first waveguide coupled to the first set of Bragg gratings;
a second set of Bragg gratings;
a second waveguide coupled to the second set of Bragg gratings;
a coupler with one side coupled to the first and second waveguides; and
a third waveguide coupled to the coupler,
wherein the optical device comprises a fourth waveguide coupled to the third waveguide via an optical interface, and wherein the first and second sets of Bragg gratings, the first, second, third, and fourth waveguides, and the coupler form an optical cavity.

14. The apparatus of claim 13, wherein the optical cavity is configured to tune a laser wavelength, and wherein a wavelength tuning range is no less than 40 nanometers.

15. The apparatus of claim 9, wherein the optical device and the SOI platform is bondable using a flip-chip method.

16. The apparatus of claim 9, wherein the optical component network comprises a first waveguide, wherein the optical device comprises a second waveguide coupled to the first waveguide via an optical interface, and wherein the SOI platform comprises a plurality of stoppers and markers configured to align the optical device such that the first and second waveguides have equal vertical and horizontal positions at the optical interface.

17. The apparatus of claim 16, wherein an angle between the first and second waveguides is greater than zero and less than 30 degrees.

18. The apparatus of claim 16, wherein the first and second waveguides both comprise a tapered portion near the optical interface, and wherein at least part of the two tapered portions vertically overlap.

19. A method comprising:
generating an optical signal using a silicon-based optical component;
applying an electrical signal to the optical component; and
tuning a wavelength of the optical signal based on the electrical signal.

20. The method of claim 19, wherein generating the optical signal comprises splitting components of the optical signal, the method further comprising:
generating an additional optical signal using an additional optical component;
applying an additional electrical signal to the additional optical component;
tuning a wavelength of the additional optical signal based on the additional electrical signal; and
multiplexing the optical signal and the additional optical signal into one optical signal.
